(19) United States
(12) Patent Application Publication
(10) Pub. No.: US 2006/0028908 A1
(43) Pub. Date: Feb. 9, 2006

(54) Micro-mixer

(76) Inventors: Arief Budiman Suriadi, Stanford, CA (US); Chorng Ing Sow, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/911,342

(22) Filed: Aug. 3, 2004

(51) Int. Cl. B01F 15/06

(52) U.S. Cl. 366/146; 366/341

(57) ABSTRACT

A micro-mixer 100 having a body in which there is disposed a micro-mixing chamber for mixing liquid. Micro-channels 108 extend from an external surface of the body of the micro-mixer 100 to the micro-mixing chamber 102 and define passageways for supplying liquid into the micro-mixing chamber 102. The micro-mixer 100 also has an electrical circuit that includes an electrical pulse generator that is connected to two or more spaced electrical heating elements 104 located in the mixing chamber 102 that receive electrical pulses from the pulse generator. In use, electrical pulses received by the heating elements 104 cause the heating elements to heat liquid in the mixing chamber in regions locally of each of the heating elements and thereby generating a vapour bubble which will, in turn, cause turbulence and mixing of liquid within the micro-mixing chamber.

### FIELD OF THE INVENTION

The invention described herein relates generally to micro-mixers and more particularly to a micro-mixer having a heating element for mixing liquids.

### BACKGROUND OF THE INVENTION

Mixing liquids on a micro-scale is presently utilized in a number of bio-medical and life science applications such as in the detection and analysis of diseases, viruses and other pathological tests. Examples of liquids that are mixed on a micro-scale include blood plasma and solutions containing DNA and reproductive cells.

Mixing liquids on a micro-scale has several advantages. For example, mixing-liquids on a micro-scale reduces the amount of liquid being consumed and from a technical point of view, can allow the analysis of microscopic specimens to selected conditions. Micro-mixers are also known as micro-electromechanical systems (MEMS) and are sometimes called micromechanical devices, micromachines, micro-fabricated devices or nano-structures. In some instances they are also colloquially known as “Labs-on-a-Chip”.

The structure of micro-mixers has been the subject of research for sometime. Conventionally micro-mixers have typically included plates, channels, baffles and other physical barriers and mechanical actuators to create turbulence within small quantities of liquid to increase uniformity and decrease the spatial gradient of different properties between liquid phases. A difficulty with some conventional micro-mixers, particularly in biological applications, is that the mechanical actuators or physical barriers can damage biological cell structures.

### SUMMARY

The present invention provides a micro-mixer having a heating element for creating a vapor bubble within liquid and thereby mixing the liquid.

According to one particular embodiment there is provided a method of mixing liquid in a micro-mixing chamber. The method includes allowing the passage of two independent liquid streams into the mixing chamber, and effecting heating of the liquid in the mixing chamber by a heating element so a bubble will be generated within the liquid in a region local to the heating element thereby causing turbulence and mixing of the liquid in the mixing chamber.

These and other features and advantages of preferred methods and micro-mixers will now be described in further detail with reference to the accompanying drawings which illustrate, by way of example, the principles of the present invention.

### BRIEF DESCRIPTION OF THE DRAWINGS

FIG. 1A illustrates a cross-sectional view of a micro mixer in accordance with an embodiment of the present invention;

FIG. 1B illustrates a plan view of the micro-mixer shown in FIG. 1A;

FIGS. 2 to 4 illustrate plan views of three alternative embodiments of micro-mixers;

FIGS. 5 and 6 illustrate cross-sectional views of micro-channels that may be incorporated in any one of the embodiments shown in FIGS. 1A to 4;

FIG. 7 illustrates an electrical circuit that may be incorporated into any one of the embodiments shown in FIGS. 1A to 4;

FIGS. 8A and 8B illustrate a non-return micro-valve that may be incorporated in any one of the embodiments shown in FIGS. 1A to 4; and

FIG. 9 is a flowchart illustrating the method steps for operating any one of the embodiments shown in FIGS. 1A to 4.

### DETAILED DESCRIPTION

Before proceeding with the detailed description, it will be appreciated by those skilled in the art of the present invention that the foregoing description of the preferred embodiments of the invention has been presented only for the purpose of illustration and description and is not intended to be exhaustive or to limit the invention to the precise forms described. Many modifications and variations may be made to the embodiments shown in the Figures without departing from the spirit and scope of the invention.

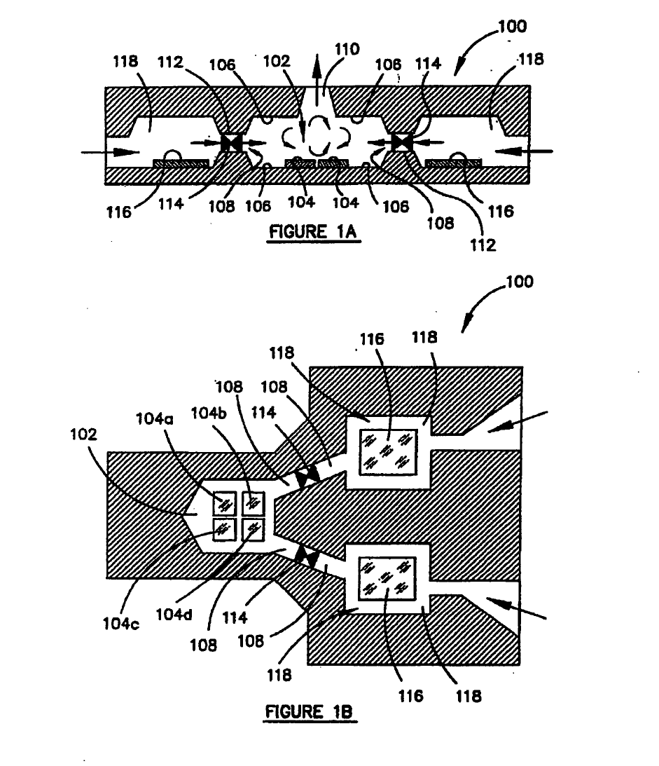

FIG. 1A is a cross-section of a body of a micro-mixer 100 in accordance with an embodiment. Incorporated into the body of the micro-mixer 100 is a micro-mixing chamber 102 having a total of four heating elements, two of which can be seen in cross section in FIG. 1A. The heating elements 104 heat liquid in the chamber 102 so as create a vapor bubble and thereby cause liquid turbulence and mixing in the mixing chamber 100. As will be explained in greater detail below, other embodiments of the present invention may include only one heating element for mixing two or more independent liquid streams.

Irrespective of whether the micro-mixer 100 includes one, two or even more heating elements, the heating element(s) for heating liquid in the micro-mixer 100 may be located inside or even outside the mixing chamber 102. In the instance when the heating elements are located inside the mixing chamber 102, the heating elements 104 may be directly or indirectly attached to internal walls 106 of the chamber 102 or even suspended within the mixing chamber 102.

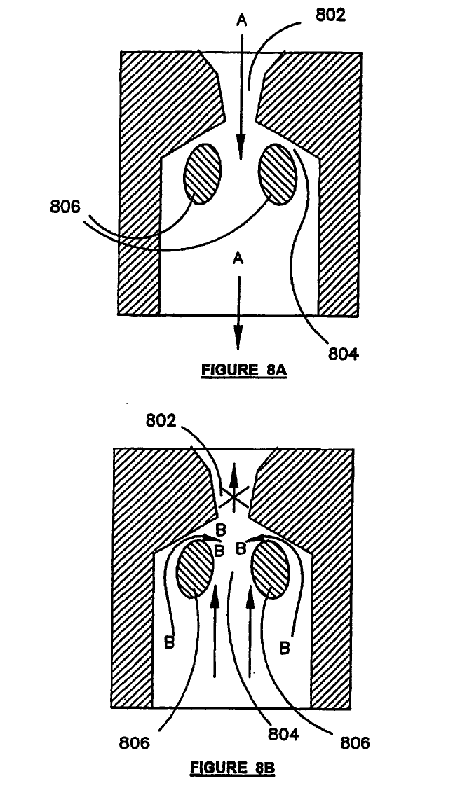

The heating elements 104 may also be capable of using various forms of energy for heating the liquid. For example, energy in the form of electromagnetic energy could be converted to heat energy by a heating element especially adapted with a receiver and energy converter. The heating elements 104 may also be of a type in which heat is thermally transferred or conducted thereto from a higher temperature source. The heating elements may also be an electrical heating element 104 that is incorporated in an electrical circuit and supplied with electrical pulses. Details of an electrical circuit for heating electrical heating elements will be described in more detail below with reference to FIG. 7. Another example of a type of electrical heating element 104 is a thermal resistor used in thermal inkjet printing cartridges.

The micro-mixer 100 shown in FIG. 1A includes two inlets 108, each for supplying liquid streams into the mixing chamber 102, and an outlet 110 through which liquid mixed in the mixing chamber 102 can be discharged. Depending on the type of liquid being mixed and the particular application of the micro-mixer 100, the outlet 110 may be flow connected to another chamber in which chemical, biological, or some other analysis can be carried out. Each inlet 108 of the mixing chamber 102 is supplied with liquid via micro-channels 112 fitted with non-return micro-valves 114.

According to the embodiment in FIGS. 1A and 1B, the liquid streams are fed into the mixing chamber 102 by another heating elements 116 heating liquid in baths 118 so as to create a vapor bubble therein and thereby displace liquid from the bath 118 through the micro-channels 112 into the mixing chamber 102. Liquid fed into the mixing chamber 102 can then be heated by the heating elements 104. Heating by the heating elements 104 creates a vapor bubble on, or in a region local to the heating elements 104, which causes turbulence and thus mixes the liquid in the mixing chamber 102.

As can be seen in FIG. 1B, four heating elements 104a to 104d are located inside the mixing chamber 102 and thus the bubble will typically form on the surface of the heating elements 104. However, in the instance when the heating elements 104 are located outside or adjacent the mixing chamber 102, the bubble is likely to form on the walls 106 of the mixing chamber 100 locally of the heating elements 104.

Furthermore, it is also possible that a plurality of vapor bubbles may be formed in the mixing chamber 102. Generating a plurality of bubbles in the mixing chamber 102 will displace liquid within the chamber 102 thereby causing mixing in much the same way as if a single bubble was formed. Turbulence and mixing may also be created when two or more bubbles migrate together and form a single bubble.

In addition, the heating elements 104 may be operated so as to closely regulate heating and thus cause size fluctuations of the vapor bubbles. More particularly, in order to enhance liquid turbulence within the mixing chamber 102, the heating elements 104 may be operated such that the total volume of the vapor bubbles increases and decreases during mixing to further enhance liquid turbulence. Upon completion of the mixing, the liquid can be heated so as to generate a bubble of sufficient size to displace the liquid from the mixing chamber 102 through the upwardly facing outlet 110. In addition to bubble formation, heat from the heating elements may also generate convection currents in the liquid in the mixing chamber 102, which in turn, can contribute to turbulence and thus liquid mixing in the mixing chamber 102.

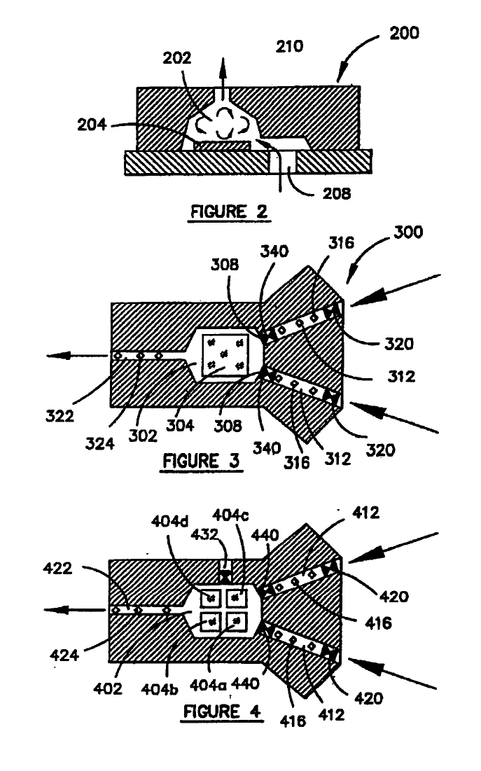

FIG. 2 illustrates an embodiment in which the micro-mixer 200 has a single heating element 204 for heating liquid in the mixing chamber 202. Two or more independent liquid streams are fed into the mixing chamber 202 via a single inlet 208.

The embodiment shown in FIG. 2, like FIG. 1A, includes a single upwardly facing outlet 210 through which liquid is discharged or shot upwardly by generating a vapor bubble of sufficient size in the mixing chamber 202.

The embodiment shown in FIG. 3 also includes a single heating element 304 for heating liquid in the mixing chamber 302. Liquid is fed into the mixing chamber 302 in two independent liquid streams that are conveyed through separate inlets 308 and micro-channels 312. Each micro-channel 312 includes further heating elements 316 and micro-valves 320 located upstream of the further heating elements 316 so that when the further heating elements 316 heat the liquid in the micro-channels 312, the micro-valves 320 prevent the reverse flow of liquid and thereby facilitates the pumping of liquid into the mixing chamber 302.

Liquid mixed in the mixing chamber 302 may be discharged from the mixing chamber 302 via the micro-channel 322. If needed, liquid in the micro-channel 322 can be pumped along the micro-channel by the further heating elements 324 forming vapor bubbles along the micro-channel 322.

Although not specifically shown in the drawings, the further heating elements 316 and 324 located in the micro-channels 312 and 322 or even in the liquid baths 118 shown in FIG. 1A, may be substituted by alternative micro-pumps such as piezoelectric and electromagnetic micro-pumps for pumping liquid.

FIG. 4 illustrates an embodiment in which the micro-mixer 400 includes 2 micro-channels 412 for supplying liquid into the mixing chambers 402 and a single micro-channel 422 for discharging mixed liquid. The micro-channels 412 and 422 include further heating elements 416 and 424 for pumping liquid into and away from the mixing chamber 402. Located in the mixing chamber 402 are 4 heating elements 404(a-d) for heating liquid in the mixing chamber; and thereby mix liquid by creating a vapor bubble. The embodiment shown in FIG. 4 also includes an inlet 432 for supplying rinsing water into the mixing chamber 402 for rinsing the chamber 402 between separate operations.

In the instance when the micro-mixer has a plurality of heating elements for heating liquid in the mixing chamber, one of ordinary skill in the art should readily recognize that it is within the scope of the present invention that the mixing chamber may be used for mixing a single liquid stream. In the instance when the micro-mixer has a single heating element for heating liquid in the mixing chamber, two or more independent liquid streams are fed into the mixing chamber.

An advantage provided by the embodiments in FIGS. 1A and 4 having a plurality of heating elements 104 and 404 is that the heating elements can heat the liquid in a cyclic sequence or even randomly. For example, the heating elements may be heated in sequences of 404a, 404b, 404c, 404d, 404a, 404b, 404c, 404d or 404a, 404d, 404b, 404c, 404a, 404b, etc or any other sequence. Heating the heating elements 104 and 404 in a cyclic sequence should further enhance liquid turbulence and thus mixing in the mixing chambers 104 and 404. The heating elements 104 and 404 may also be heated so that the periods over which the heating elements 104 and 404 are heated may take place in consecutive periods one after the other, in overlapping periods, or in disjunctively periods that are separated by pauses.

In the instance when the heating element is an electrical heating element, the micro-mixer will include an electrical circuit such as the electrical circuit 700 illustrated in FIG. 7. The circuit includes a series of heating elements 704 that represent the heating elements for heating liquid in a mixing chamber 102, 202, 302 and 402. One or more heating elements identified by reference numeral 716 represents the further heating elements 116, 216, 316 and 416 located in the liquid baths 118 or micro-channels 312 and 412 for pumping liquid into the mixing chambers.

The circuit also includes a power source 726 and a pulse generator 728 having one or more adjustment knobs 730 for controlling the output of the pulse generator 728. In particular, the control knob 730 may be used to adjust any one or a combination of the following characteristics of the pulse that may include, but is not limited to, frequency, magnitude and sequencing of the pulses.

Another factor effecting mixing is the total periods over which the heating elements 104, 204, 304 and 404 are heated, and the temperature to which the heating elements 104, 204, 304 and 404 are heated. These characteristics or features may also be adjusted using the control knob 730.

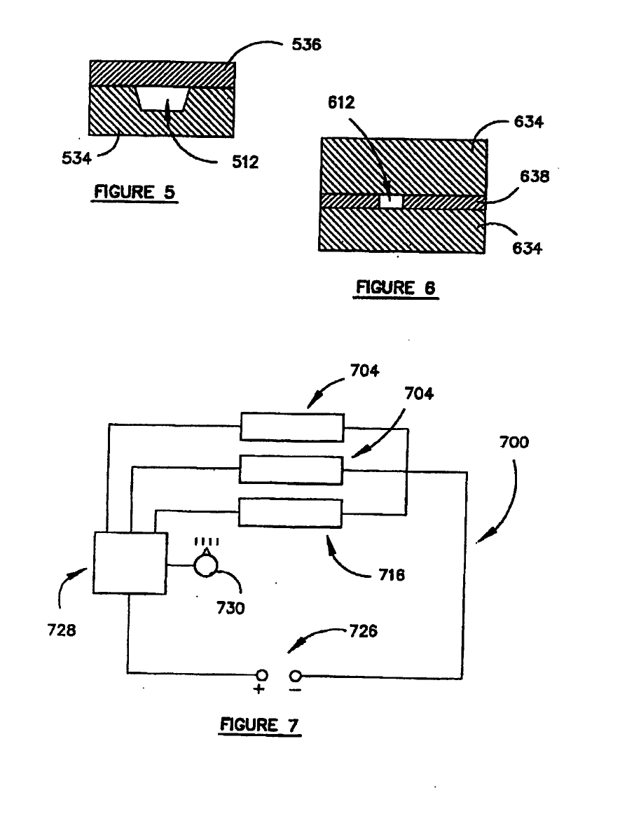

FIG. 5 illustrates a cross sectional view of a micro-channel incorporated in the body or substrate of a micro-mixer. In particular, the body or substrate includes a silicon material 534 in which a micro-channel 512 is etched using suitable techniques. A dry film 536 is then laid over the micro-channel 512 to form a sealed passageway.

FIG. 6 illustrates a cross sectional view of a micro-channel incorporated in the body or substrate of a micro-mixer. The body or substrate of the micro-mixer includes a polyimide photoimageable material 638 having a slot formed therein that defines a micro-channel 612. The polyimide material 638 is disposed between two silicon wafer layers 634.

The micro-channels 312 and 412 shown in FIGS. 3 and 4 may have a configuration according to any one of the channels shown in FIGS. 5 and 6. The micro-channels 312 and 412 for supplying independent liquid stream into the mixing chambers 302 and 404 extend from an external surface of the body or substrate of the micro-mixers 200 and 300. The micro-channels 312 and 412 also include micro-valves 240 and 340 for regulating or preventing the flow of the liquid therein.

At present there are a number of micro-valves that are available for micro-mixer systems including piezoelectric valves, thermoneumatic valves, high voltage or electrostatic valves and electromagnetic valves. Another type of micro-valve is known as a hydrogel-based valve and includes a hyrdogel that expands and contracts in response to an external power supply or other elements such as pH, temperature, electrical fields, light, carbohydrates, antigents etc. An advantage in using a hydrogel micro-valve is that it is simple in structure and has fast responses that allow the micro-channel to be opened and closed as desired.

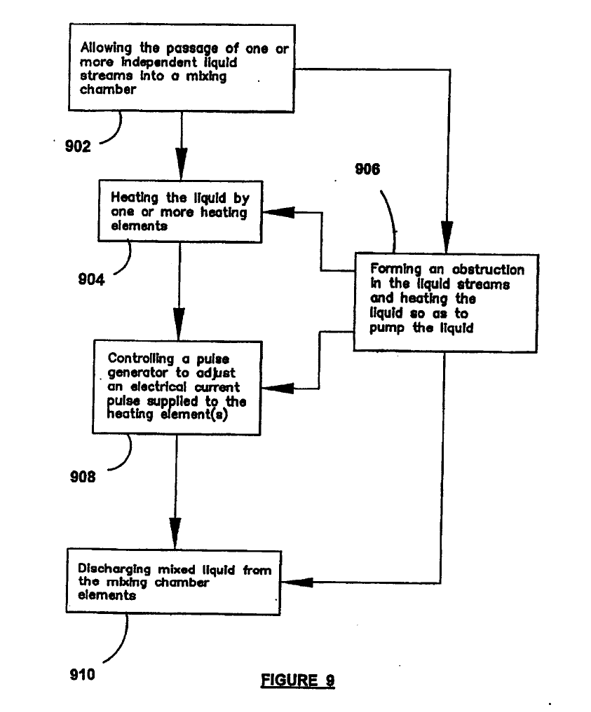

FIGS. 8A and 8B illustrate the design of a non-return micro-valve having a configuration adapted to allow the flow of liquid in the direction of arrows A in FIG. 8A and prevent flow of liquid in the reverse direction shown in FIG. 8B. In particular, the valve is configured such that liquid passes through a narrow region 802 located up stream of a broader region 804 that is substantially wider than the narrow region 802. The broader region 804 also accommodates two obstructions 806 so that when liquid attempts to flow in the reverse direction as shown in FIG. 8B, liquid turbulence in the direction of arrows B is generated around the obstructions 804 and thereby substantially prevents liquid flow in a reverse direction through the narrow region 802.

The types of micro-valves described above or any other type may be included in the embodiments shown in the Figures.

FIG. 9 illustrates the method steps for operating any one of the embodiments shown in FIGS. 1a to 4. Steps 902 and 904 involve allowing the passage of independent liquid streams into the mixing chamber and heating the liquid in the mixing chamber by one or more heating elements. Although not expressly mentioned in FIG. 9, in the situation when two or more independent liquid streams are fed into the mixing chamber, step 904 may involve heating the liquid with one or more heating elements. However, in the situation when only one independent liquid stream is mixed in the mixing chamber, step 904 involves heating the liquid by two or more heating elements.

Step 908 represents a situation in which the heating elements are electrical heating elements incorporated in an electrical circuit that includes a pulse generator and the output of the pulse generator is received by the electrical heating elements for heating liquid in the mixing chamber. It will be appreciated from the above description that the heating elements need not necessarily be electrical heating elements.

Step 906 represents a situation in which each iquid stream is pumped into the mixing chamber by way of further heating elements. Specifically, the method involves heating the liquid streams by the further heating and forming an obstruction upstream of the further heating element such as by closing a micro-valve so that bubbles generated cause displacement of the liquid into the mixing chamber. It will be appreciated from the above discussion that the further heating elements and micro-valves may be substituted with alternative pumping mechanisms for pumping liquid streams into the mixing chamber.

Step 910 represents the step of discharging liquid mixed in the mixing chamber. This step is at least in part achieved by forming a vapor bubble of sufficient size in the mixing chamber that can displace mixed liquid from the mixing chamber through an outlet.

Throughout this specification, the term liquid, or liquid stream embraces, but is by no means limited to, solutions containing a mixture of different liquid phases and dissolves constituents, and solutions containing one or more solid particles so as to form a suspension or slurry.

The previous description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of mixing a liquid in a micro-mixing chamber comprising:
allowing passage of liquid in two independent liquid streams into the mixing chamber; and
effecting heating of the liquid in the mixing chamber by a heating element so a bubble will be generated within the liquid in the mixing chamber in a region locally of the heating element, and as a consequence causing turbulence and mixing of the liquid.

2. The method according to claim 1, wherein the heating element is an electrical heating element heated by an electric current supplied from an electrical current pulse generator circuit, said method including controlling the pulse generator circuit to adjust the electrical current pulse, to, in turn, control expansion of the bubble created, and thereby control the liquid turbulence and mixing in the mixing chamber.

3. The method according to claim 1, further comprising forming an obstruction to the stream at a location distant from the mixing chamber, and heating the liquid in said stream between the obstruction and the mixing chamber by another heating element so as to generate a bubble within a region locally of the further heating element and pumping said liquid into the mixing chamber by the creation of the bubble and the consequent liquid displacement.

4. The method according to claim 3, wherein the heating element is an electric heating element heated by an electric current supplied from a further electric pulse generator circuit, and controlling the further electric pulse generator circuit to adjust the electric current pulse, to, in turn, control expansion of a bubble created, to thereby control the volume of liquid pumped into said mixing chamber.

5. The method according to claim 1, further comprising displacing the mixed liquid from the mixing chamber.

6. The method according to claim 5, comprising displacing the mixed liquid by heating the mixed liquid by the heating element to form one or more bubbles that have sufficient magnitude to displace the mixed liquid from the mixing chamber.

7. The method according to claim 5, comprising displacing the mixed liquid from the mixing chamber in a liquid stream independent of the liquid streams that allow passage of liquid into the mixing chamber.

8. A method of mixing a liquid in a micro-mixing chamber comprising:
effecting heating of the liquid in the mixing chamber by two or more spaced heating elements so there will be bubble creation within the liquid in the mixing chamber in regions local to each of the two or more heating elements thereby causing turbulence and mixing of the liquid.

9. The method according to claim 8, further comprising allowing the heating elements to be heated in a cyclic sequence to further enhance turbulence and mixing of the liquid.

10. The method according to claim 9, wherein the heating elements are electrical heating elements heated by an electric current supplied from an electrical current pulse generating circuit, said method further including heating the heating elements in a cyclic sequence by supplying appropriate electric current pulses from the electrical current pulse generating circuit.

11. The method according to claim 9, comprising causing the liquid mixed in the mixing chamber to be supplied thereto by two or more independent liquid streams that flow into said mixing chamber.

12. The method according to claim 8, further comprising displacing the mixed liquid from the mixing chamber.

13. The method according to claim 12, comprising displacing the mixed liquid by heating the mixed liquid by the heating elements to form one or more bubbles that have sufficient magnitude to displace the mixed liquid from the mixing chamber.

14. The method according to claim 12, comprising displacing the mixed liquid from the mixing chamber in a liquid stream independent of the liquid streams that allow passage of liquid into the mixing chamber.

15. A micro-mixer comprising:
a body;
a mixing chamber in the body; and
at least two liquid inlets to the mixing chamber in the body to allow passage of liquid in two independent liquid streams into the mixing chamber, said body carrying a heating element disposed so that when heated to a suitable temperature, a bubble will form in the liquid in the mixing chamber in a region local to the heating element thereby causing turbulence and mixing of the liquid.

16. The micro-mixer according to claim 15, further including:
a liquid flow controller for controlling the volume at which one of the streams flows into the mixing chamber, said liquid flow controller including a micro-valve that can be opened and closed to obstruct said stream at a distance from the mixing chamber, and at least one heating element downstream of the micro-valve that can heat the liquid in the stream when the micro-valve is closed so that a bubble will be generated within a region locally of the heating element and will cause the liquid in the stream to pump into the chamber as a consequence of the liquid displacement caused by the creation of the bubble.

17. The micro-mixer according to claim 15, wherein the heating element is an electrical heating element heated by an interconnected electric current supplied from an electrical current pulse generating circuit, and wherein the pulse generator circuit can be adjusted to control the electrical current pulse, and, in turn, control expansion of the bubble created to, in turn, control liquid turbulence and mixing in the mixing chamber.

18. The micro-mixer according to claim 15, wherein the body further includes at least one bath of liquid which is flow connected to the inlet,
said bath carrying at least one heating element so that when heated to a suitable temperature, a bubble will be created in the bath in a region locally of the heating element and thereby cause liquid within the bath to displace from the bath into the mixing chamber via the inlet.

19. The micro-mixer according to claim 15, wherein one of said inlets that allow the passage of liquid into the mixing chamber is adapted to be able to act as an outlet so that liquid mixed in the mixing chamber can be discharged from the mixing chamber.

20. The micro-mixer according to claim 15, further comprising an outlet to the mixing chamber, independent of the inlets, through which mixed liquid can be discharged from the mixing chamber.

21. The micro-mixer according to claim 19 or 20, wherein the mixed liquid is discharged from the mixing chamber by the heating element heating the mixed liquid to form one or more bubbles that have sufficient magnitude to displace the mixed liquid from the mixing chamber.

22. A micro-mixer comprising:
a body;
a mixing chamber in the body containing liquid to be mixed; and
an electrical pulse generator, said body carrying two or more spaced electric heating elements for receiving electrical pulses in a cyclic sequence from the pulse generator for heating the liquid in the mixing chamber in regions locally of each of the electric heating elements and thereby cause turbulence and mixing of the liquid.

23. The micro mixer according to claim 22, wherein the electrical pulses supplied to the respective electric heating elements are controllable by the electric pulse generator to occur over periods that either overlap or occur disjunctively.

24. The micro-mixer according to claim 22, comprising two independent liquid streams for supplying liquid to the mixing chamber.

25. The micro-mixer according to claim 22, further including a liquid flow controller for controlling the volume at which one of the streams flows into the mixing chamber, said liquid flow controller including a micro-valve that can be opened and closed to obstruct said stream at a distance from the mixing chamber and at least one heating element downstream of the micro-valve that can heat the liquid in the stream when the micro-valve is closed so that a bubble generated within a region locally of the heating element will cause the liquid in the stream to pump into the chamber by the creation of the bubble and the consequent liquid displacement.

26. The micro-mixer according to claim 24, wherein the body further includes:
at least one bath and a passage therefrom from which one of said independent streams is flow connected to the inlet,
said bath carrying at least one heating element so that when heated to a suitable temperature, a bubble will be created in the bath in a region locally of the heating element and thereby cause liquid within the bath to pass from the bath into the mixing chamber.

27. The micro-mixer according to claim 24, wherein the direction of flow in one of said liquid streams can be reversed so that liquid mixed in the mixing chamber can be discharged from the mixing chamber through said stream.

28. The micro-mixer according to claim 24, further comprising an outlet to the mixing chamber, independent of the liquid streams for supplying liquid into the mixing chamber, through which mixed liquid can be discharged from the mixing chamber.

29. The micro-mixer according to claim 28, wherein the mixed liquid is discharged from the mixing chamber by the heating elements heating the mixed liquid to form one or more bubbles that have sufficient magnitude to displace the mixed liquid from the mixing chamber.

30. A micro-mixer comprising:
a substrate, said substrate having a layer defining at least two micro-channels that extend from external surface regions of said substrate to a mixing chamber within the substrate;
a covering over the micro-channels whereby the micro-channels are sealed except where they terminate with the external surface regions of the substrate and the mixing chamber, said micro-channels permitting passage of liquid into the mixing chamber in two independent streams; and
a heating element carried by the substrate, said heating element disposed so that when the liquid in the mixing chamber is heated thereby to a suitable temperature, a bubble will be generated in a region local to the heating element thereby causing turbulence and mixing of the liquid in the mixing chamber.

31. The micro-mixer according to claim 30, further including a liquid flow controller for controlling the volume at which one of the streams flows into the mixing chamber, said liquid flow controller including a micro-valve that can be opened and closed to obstruct the flow along one of the channels at a distance from the mixing chamber and at least one heating element downstream of the micro-valve that can heat the liquid in the stream so that when the micro-valve is closed a bubble will be generated within a region locally of the heating element that will cause the liquid in the stream to pump into the mixing chamber.

32. The micro-mixer according to claim 30, wherein the heating element is an electrical heating element heated by an electric current supplied from an electrical current pulse generator circuit connected therewith, the pulse generator circuit being controllable to adjust the electrical current pulse, to, in turn, control expansion of the bubble created, so there can be control of liquid turbulence and mixing in the mixing chamber.

33. The micro-mixer according to claim 30, wherein the body further includes at least one bath of liquid which is flow connected to the inlet,
said bath carrying at least one heating element so that when heated to a suitable temperature, a bubble will be created in the bath in a region locally of the heating element and thereby cause liquid within the bath to pass from the bath into the mixing chamber via one of the micro-channels.

34. The micro-mixer according to claim 30, wherein the direction of flow in one of said micro-channels can be reversed so that liquid mixed in the mixing chamber can be discharged from the mixing chamber through said micro-channel.

35. The micro-mixer according to claim 30, further comprising an outlet to the mixing chamber, independent of the micro-channels, through which mixed liquid can be discharged.

36. The micro-mixer according to claim 34 or 35, wherein the mixed liquid is discharged from the mixing chamber by the heating element heating the mixed liquid to form one or more bubbles that have sufficient magnitude to displace the mixed liquid from the mixing chamber.
